(19) United States
(12) Patent Application Publication
(10) Pub. No.: US 2026/0031497 A1
(43) Pub. Date: Jan. 29, 2026

(54) BATTERY CELL WITH IMPROVED ELECTRIC RESISTANCE AND UNIFORM CURRENT DENSITY

(71) Applicant: GM GLOBAL TECHNOLOGY OPERATIONS LLC, Detroit, MI (US)

(72) Inventors: Sherman H. Zeng, Troy, MI (US); Xu Xian Hou, Warren, MI (US); Changkeun Yoo, Seoul (KR); Jingyuan Liu, Shanghai (CN); David R. Clark, Grosse Pointe Woods, MI (US); John Christian Kalil, Washington, MI (US)

(73) Assignee: GM GLOBAL TECHNOLOGY OPERATIONS LLC, Detroit, MI (US)

(21) Appl. No.: 18/829,073

(22) Filed: Sep. 9, 2024

(30) Foreign Application Priority Data
Jul. 25, 2024 (CN) 202411004302.6

(51) Int. Cl. H01M 50/533; H01M 10/0585; H01M 50/503

(52) U.S. Cl. CPC H01M 50/533; H01M 10/0585; H01M 50/503

(57) ABSTRACT

A battery cell and a battery cell module and a method of forming batteries with improved electric resistance and uniform current density are provided. The battery cell includes a first and a second negative electrodes and a first and second positive electrodes, each having defined length and width, with multiple tabs extending outward from one side along the width direction. When stacked, the tabs of the first and second negative electrodes are located on the same side in an alternating arrangement, substantially covering the entire electrode length, and the tabs of the first and second positive electrodes are located on the opposite side in an alternating arrangement, substantially covering the entire electrode length. The battery cell further includes busbars with various configurations to ensure effective electrical connections.

### INTRODUCTION

The present disclosure relates to battery cells, and more particularly to battery cells having electrodes with full tabs, battery modules, and methods for making the same.

Lithium-ion batteries describe a class of rechargeable batteries in which lithium ions move between a negative electrode (i.e., anode) and a positive electrode (i.e., cathode). Liquid and polymer electrolytes can facilitate the movement of lithium ions between the anode and cathode. Lithium-ion batteries are growing in popularity for defense, automotive, and aerospace applications due to their high energy density and ability to undergo successive charge and discharge cycles.

The electrodes of traditional elongate or N-type and prismatic or P-type lithium-ion batteries exhibit characteristics such as high resistance, poor thermal performance, and ununiform current density, which negatively impact the safety and durability of the batteries. Furthermore, these issues related to resistance and current density may limit the performance of elongate type battery cell with large size in length direction.

It is desirable to make battery cells using method of forming batteries with improved electric resistance and uniform current density. Furthermore, other desirable features and characteristics of the variations disclosed herein will become apparent from the subsequent detailed description and the appended claims, taken in conjunction with the accompanying drawings and the foregoing.

### SUMMARY

Provided is an embodiment of a battery cell. The battery cell includes: a first negative electrode having a first defined length in a first direction and a first defined width in a second direction, wherein the first negative electrode includes tabs extending outward from one side in the second direction, and a first positive electrode having the first defined length in the first direction and the first defined width in the second direction, wherein the first positive electrode includes tabs extending outward from one side in the second direction. The first negative electrode and the first positive electrode are stacked together with a first separator configured therebetween to form a first battery cell stack in which the tabs on the first negative electrode and the tabs on the first positive electrode are located on an opposite side in an alternating arrangement, substantially covering an entire length of the first battery cell stack.

In an embodiment, the number of tabs on each of the first negative electrode and the first positive electrode is greater than 3.

In an embodiment, the height of the tabs on the first negative electrode and the first positive electrode is between 5 mm and 15 mm, preferably between 7.5 mm and 10 mm, and the width of the tabs on the first negative electrode and the first positive electrode is between 30 mm and 70 mm, preferably between 40 mm and 60 mm.

In an embodiment, the battery cell further includes a second negative electrode having a second defined length and a second defined width, wherein the second negative electrode includes tabs extending outward from one side in the second direction, a second positive electrode having the second defined length and the second defined width, wherein the second positive electrode includes tabs extending outward from one side in the second direction. The second negative electrode and the second positive electrode are stacked together with a second separator configured therebetween to form a second battery cell stack in which the tabs on the second negative electrode and the tabs on the second positive electrode are located on an opposite side in an alternating arrangement, substantially covering an entire length of the second battery cell stack. The first battery cell stack and the second battery cell stack are stacked together with a third separator configured therebetween to form the battery cell in which the tabs on the first negative electrode and the second negative electrode are located on a same side of the battery cell in an alternating arrangement, substantially covering an entire length of the battery cell, and the tabs on the first positive electrode and the second positive electrode are located on an opposite side of the battery cell in an alternating arrangement, substantially covering the entire length of the battery cell.

In an embodiment, the first defined length is equal to the second defined length and the first defined width is equal to the second defined width.

In an embodiment, the first negative electrode and the second negative electrode have the same number of tabs as the first positive electrode and the second positive electrode.

In an embodiment, the battery cell further includes a busbar, wherein the busbar includes a head, a shoulder, and two parallel legs connected to the shoulder with a gap therebetween, wherein the length of the busbar is the same as the length of the battery cell, and the busbar is connected to the tabs located on a same side of the battery cell, and the tabs pass through the gap, and each leg is connected to all the tabs of a respective electrode.

In an embodiment, the battery cell further includes a busbar, wherein the busbar has a strip-shaped solid structure, the length of the busbar being the same as the length of the battery cell, wherein the busbar is connected to the tabs located on a same side of the battery cell such that the tabs on different electrodes are located on opposite sides of the busbar.

In an embodiment, the length of the battery cell is at least 200 mm.

In an embodiment, the length of the battery cell is between 200 mm and 1,500 mm.

Also provided is a battery cell module, including multiple battery cells, wherein each battery cell includes: a first negative electrode having a first defined length in a first direction and a first defined width in a second direction, wherein the first negative electrode includes tabs extending outward from one side in the second direction, a first positive electrode having the first defined length in the first direction and the first defined width in the second direction, wherein the first positive electrode includes tabs extending outward from one side in the second direction, wherein the first negative electrode and the first positive electrode are stacked together with a first separator configured therebetween to form a first battery cell stack in which the tabs on the first negative electrode and the tabs on the first positive electrode are located on an opposite side in an alternating arrangement, substantially covering an entire length of the first battery cell stack, a second negative electrode having a second defined length and a second defined width, wherein the second negative electrode includes tabs extending outward from one side in the second direction, and a second positive electrode having the second defined length and the second defined width, wherein the second positive electrode includes tabs extending outward from one side in the second direction, wherein the second negative electrode and the second positive electrode are stacked together with a second separator configured therebetween to form a second battery cell stack in which the tabs on the second negative electrode and the tabs on the second positive electrode are located on an opposite side in an alternating arrangement, substantially covering an entire length of the second battery cell stack. The first battery cell stack and the second battery cell stack are stacked together with a third separator configured therebetween to form the battery cell in which the tabs on the first negative electrode and the second negative electrode are located on a same side of the battery cell in an alternating arrangement, substantially covering an entire length of the battery cell, and the tabs on the first positive electrode and the second positive electrode are located on an opposite side of the battery cell in an alternating arrangement, substantially covering the entire length of the battery cell. In addition, each battery cell is stacked with a fourth separator and a fifth separator configured on opposite sides of the battery cell, respectively.

In an embodiment of the battery module, the number of tabs on each electrode is greater than 3.

In an embodiment of the battery module, the height of the tabs on each electrode is between 5 mm and 15 mm, preferably between 7.5 mm and 10 mm, and the width is between 30 mm and 70 mm, preferably between 40 and 60 mm.

In an embodiment of the battery module, the first negative electrode and the second negative electrode have a same length and a same width as the first positive electrode and the second positive electrode.

In an embodiment of the battery module, the first negative electrode and the second negative electrode have the same number of tabs as the first positive electrode and the second positive electrode.

In an embodiment of the battery module, each battery cell further includes: a busbar, wherein the busbar includes a head, a shoulder, and two parallel legs connected to the shoulder with a gap between them, the length of the busbar being the same as the length of the battery cell, and the busbar is connected to the tabs located on a same side of the battery cell, the tabs pass through the gap, and each leg is connected to all of the tabs of a respective electrode.

In an embodiment of the battery module, each battery cell further includes: a busbar for the positive or negative electrode, wherein the busbar has a strip-shaped solid structure, a length of the busbar being the same as a length of the battery cell, wherein the busbar is connected to the tabs located on a same side of the battery cell, and the tabs of adjacent electrodes are located on opposite sides of the busbar.

In an embodiment of the battery module, the length of each battery cell is at least 200 mm.

In an embodiment of the battery module, the length of the battery cells is between 200 mm and 1500 mm.

Also provided is a method for forming batteries, including the following steps: feeding a first foil through a coating machine, wherein movement of the first foil defines a first foil direction; applying a first coating strip to the first foil; applying a second coating strip to the first foil, wherein the second coating strip is spaced from the first coating strip by a first tab gap, and the width of the second coating strip is twice the width of the first coating strip; applying a third coating strip to the first foil, wherein the third coating strip is spaced from the second coating strip by a second tab gap, and the width of the third coating strip is the same as the width of the first coating strip; cutting the second coating strip and the first foil midway parallel to the first foil direction; cutting the first foil substantially perpendicular to the first foil direction to separate a first coated blank having a first half portion of the second coating strip and a second coated blank having a second half portion of the second coating strip; cutting the first coated blank to separate the first coating strip and a first set of plurality of tabs and separate the first half portion of the second coating strip and a second set of plurality of tabs, wherein a first electrode is formed from the first coating strip and the first set of plurality of tabs, and a second electrode is formed from the first half portion of the second coating strip and the second set of plurality of tabs; and feeding a second foil through the coating machine, wherein movement of the second foil defines a second foil direction; applying a fourth coating strip to the second foil; applying a fifth coating strip to the second foil, wherein the fifth coating strip is spaced from the fourth coating strip by a third tab gap, and the width of the fifth coating strip is twice the width of the fourth coating strip; applying a sixth coating strip to the second foil, wherein the sixth coating strip is spaced from the fifth coating strip by a fourth tab gap, and the width of the sixth coating strip is the same as the width of the fourth coating strip; cutting the fifth coating strip and the second foil midway parallel to the second foil direction; cutting the second foil substantially perpendicular to the second foil direction to separate a third coated blank having a first half portion of the fifth coating strip and a fourth coated blank having a second half portion of the fifth coating strip; cutting the third coated blank to separate the fourth coating strip and a third set of plurality of tabs and separate the first half portion of the fifth coating strip and a fourth set of plurality of tabs, wherein a third electrode is formed from the fourth coating strip and the third set of plurality of tabs, and a fourth electrode is formed from the first half portion of the fifth coating strip and the fourth set of plurality of tabs, wherein the first coating strip, the second coating strip and the third coating strip are formed from a same active material, which is one of an anodic material and a cathodic material, and the fourth coating trip, the fifth coating strip and the sixth coating strip are formed from a same active material, which has an opposite polarity with the active material of the first coating strip, the second coating strip and the third coating strip; stacking the first electrode and the third electrode with a first separator configured therebetween to form a first battery cell stack in which the first set of plurality of tabs and the third set of plurality of tabs are located on an opposite side in an alternating arrangement, substantially covering an entire length of the first battery cell stack; stacking the second electrode and the fourth electrode with a second separator configured therebetween to form a second battery cell stack in which the second set of plurality of tabs and the fourth set of plurality of tabs are located on an opposite side in an alternating arrangement, substantially covering an entire length of the second battery cell stack; and stacking the first battery cell stack and the second battery cell stack together with a third separator configured therebetween to form a battery cell in which the tabs on the first electrode and the second electrode are located on a same side of the battery cell in an alternating arrangement, substantially covering an entire length of the battery cell, and the tabs on the third electrode and the fourth electrode are located on an opposite side of the battery cell in an alternating arrangement, substantially covering the entire length of the battery cell.

In an embodiment, the coating strips can be applied at the same time.

### BRIEF DESCRIPTION OF THE DRAWINGS

The exemplary embodiments will hereinafter be described in conjunction with the following drawing figures, wherein like numerals denote like elements, and wherein:

FIG. 1A is an illustration of the front view of an electrode in accordance with various embodiments of the present disclosure;

FIG. 1B is an illustration of the front view of another electrode, which has alternate tab positions and the same polarity as the electrode of FIG. 1A, in accordance with various embodiments of the present disclosure;

FIG. 2A is an illustration of the front view of an electrode, which has the opposite polarity to the electrode of FIG. 1A, in accordance with various embodiments of the present disclosure;

FIG. 2B is an illustration of the front view of another electrode, which has alternate tab positions and the same polarity as the electrode of FIG. 2A, in accordance with various embodiments of the present disclosure;

FIG. 3 is an illustration of the front view of battery cell in accordance with various embodiments of the present disclosure;

FIG. 4A is an illustration of the top view of a busbar and its connection to multiple tabs, in accordance with various embodiments of the present disclosure;

FIG. 4B is an illustration of the cross-sectional view of one of the busbar legs of FIG. 4A and the tab connected to it along the line AA, in accordance with various embodiments of the present disclosure;

FIG. 4C is an illustration of the cross-sectional view of one of the busbar legs of FIG. 4A and the tab connected to it along the line BB, in accordance with various embodiments of the present disclosure;

FIG. 4D is an illustration of the top view of another busbar and its connection to multiple tabs, in accordance with various embodiments of the present disclosure;

FIG. 5 is an illustration of a coating process of a method for making a battery cell, in accordance with various embodiments of the present disclosure; and

FIG. 6 is an illustration of a method for making a battery cell, in accordance with various embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used herein, the term “battery cell” or “battery cell stack” refers to the most basic unit of the lithium-ion battery, which has two electrodes and can operate as a battery. However, as used herein, as shown in the figures of the present disclosure, to achieve the effects of the present invention, the positive or negative electrode of the battery cell may be formed by stacking two (or more) electrode units. In addition, as used herein, the term “module” is used to refer to a plurality of operatively connected battery cells or battery cell stacks. Generally, the term “pack” refers to a plurality of operatively connected modules.

Much of the description herein refers to lithium-ion battery components. However, the structures, methods, and apparatuses described herein may be applied to other battery chemistry types.

While the present disclosure may be described with respect to specific applications or industries, those skilled in the art will recognize the broader applicability of the disclosure. Those having ordinary skill in the art will recognize that terms such as “above,” “below,” “upward,”, “outward” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting the claims or the description.

As used herein, the term substantially refers to relationships that are, ideally perfect or complete, but where manufacturing realities prevent absolute perfection. Therefore, substantially denotes typical variance from perfection. For example, if height A is substantially equal to height B, it would be preferred that the two heights are 100.0% equivalent, but manufacturing realities likely result in the distances varying from such perfection. Skilled artisans would recognize the amount of acceptable variance.

For example, coverages, areas, or distances may generally be within 10% of perfection for substantial equivalence. Similarly, relative alignments, such as parallel or perpendicular, may generally be within 5%.

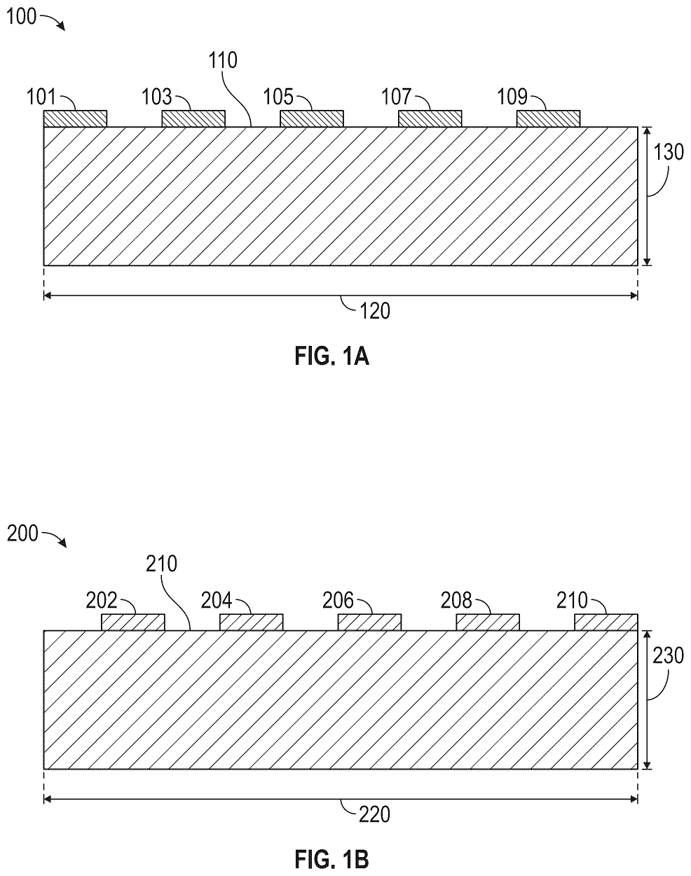

FIG. 1A illustrates a first negative electrode 100 which has a defined length 120 between opposite ends and width 130 between opposite sides. In various embodiments, tabs 101, 103, 105, 107, and 109 extend outward from one side in the width direction, i.e., extends outwards and away from the side. In various embodiments, each of the five tabs has an identical height and an identical width, and the space between two adjacent tabs is the same as the width of each tab itself. One side of tab 101 coincides with one side of the first electrode 100; therefore, the width of each tab is one-tenth of the length 120 of the first electrode 100, as shown in the embodiment of FIG. 1A.

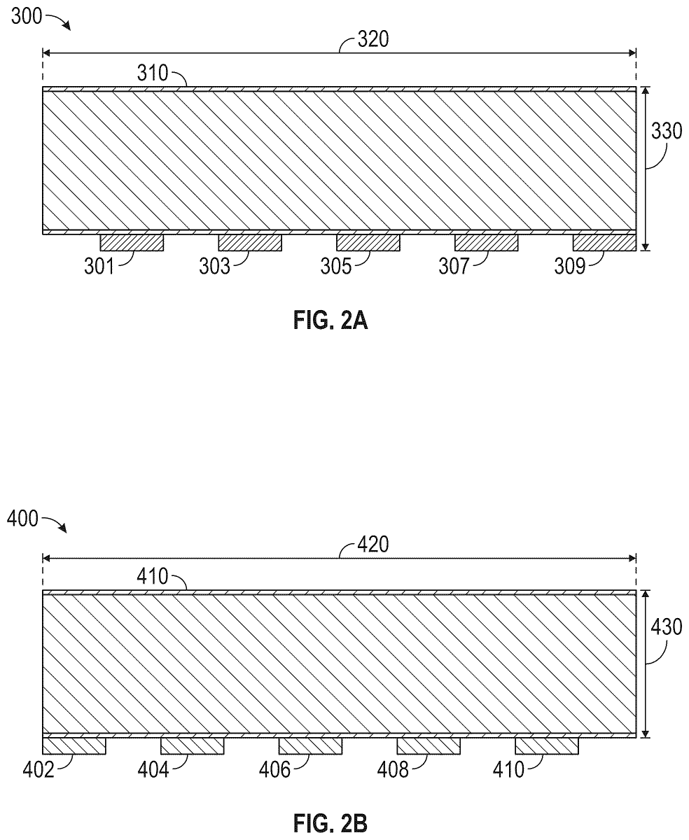

FIG. 2A illustrates a first positive electrode 300 which has a defined length 320 and width 330. In various embodiments, tabs 301, 303, 305, 307, and 309 extend outward from one side in the width direction. In various embodiments, each of the five tabs has an identical height and an identical width, and the space between two of the tabs is the same as the width of each tab itself. One side of tab 309 coincides with one side of the first positive electrode 300; therefore, the width of each tab is one-tenth of the length 320 of the first positive electrode 300.

FIG. 1B illustrates a second negative electrode 200 which has a defined length 220 between opposite ends and width 230 between opposite sides. In various embodiments, tabs 202 204, 206, 208, and 210 extend outward from one side in the width direction, i.e., extends outwards and away from the side. In various embodiments, each of the five tabs has an identical height and an identical width, and the space between two adjacent tabs is the same as the width of each tab itself. One side of tab 210 coincides with one side of the second negative electrode 200; therefore, the width of each tab is one-tenth of the length 220 of the second negative electrode 200, as shown in the embodiment of FIG. 1B.

FIG. 2B illustrates a second positive electrode 400 which has a defined length 420 and width 430. In various embodiments, tabs 402, 404, 406, 408, and 410 extend outward from one side in the width direction. In various embodiments, each of the five tabs has an identical height and an identical width, and the space between two of the tabs is the same as the width of each tab itself. One side of tab 402 coincides with one side of the second positive electrode 400; therefore, the width of each tab is one-tenth of the length 420 of the second positive electrode 400.

In various embodiments, electrodes 100 and 200 are made of negative electrode and electrodes 300 and 400 are made of positive electrode materials. In other embodiments, electrodes 100 and 200 are made of positive electrode materials while electrodes 300 and 400 are made of negative electrode materials.

In various embodiments, the first negative electrode 100 and the first positive electrode 300 have the same length and width, and tabs 101, 103, 105, 107, and 109 have the same size and shape as tabs 301, 303, 305, 307, and 309. The first negative electrode 100 is placed on the top of a first piece of separator. A second piece of separator is put on the top of the first negative electrode 100, then the first positive electrode 300 are stacked to the top of the second piece of separator. A third piece of separator then is put on the top of the first positive electrode 300. The second negative electrode 200 now is added on the top of the third piece of separator. After adding a fourth piece of separator, the second positive electrode 400 is put on the top, followed by a fifth piece of separator on the top of the second positive electrode 400. This process will assemble an electrochemical cell with two negative electrodes, 100 and 200, and two positive electrodes 300 and 400, stacking together.

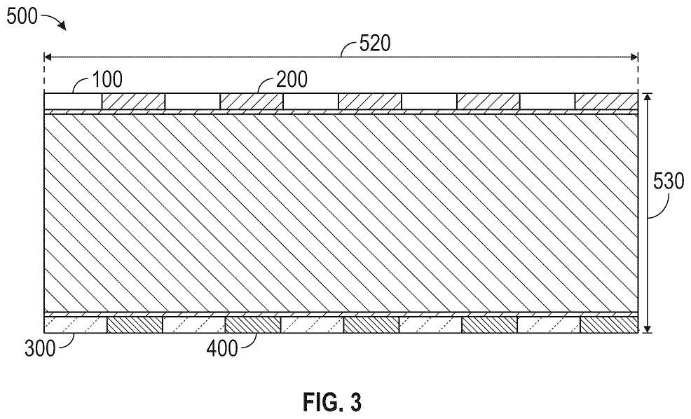

In various embodiments, the first negative electrode 100 and the first positive electrode 300 are stacked together with a first separator configured therebetween to form a first battery cell stack (not shown) in which the tabs 101, 103, 105, 107, and 109 on the first negative electrode 100 and the tabs 301, 303, 305, 307, and 309 on the first positive electrode 300 are located on an opposite side in an alternating arrangement, substantially covering an entire length of the first battery cell stack. The second negative electrode 200 and the second positive electrode 400 are stacked together with a second separator configured therebetween to form a second battery cell stack (not shown) in which the tabs 202 204, 206, 208, and 210 on the second negative electrode 200 and the tabs 402, 404, 406, 408, and 410 on the second positive electrode 400 are located on an opposite side in an alternating arrangement, substantially covering an entire length of the second battery cell stack. Then the first battery cell stack and the second battery cell stack are stacked together with a third separator configured therebetween to form the battery cell 500 in which the tabs 101, 103, 105, 107, 109, 202 204, 206, 208, and 210 on the first negative electrode 100 and the second negative electrode 200 are located on the same side of the battery cell in an alternating arrangement, substantially covering an entire length of the battery cell 500, and the tabs 301, 303, 305, 307, 309, 402, 404, 406, 408, and 410 on the first positive electrode 300 and the second positive electrode 400 are located on an opposite side of the battery cell 500 in an alternating arrangement, substantially covering the entire length of the battery cell 500 (as shown in FIG. 3). In various embodiments, the battery cell is stacked with a fourth separator and a fifth separator configured on opposite sides of the battery cell, respectively. This stacking process could achieve the same effect as the above-mentioned process.

In various embodiments, the first negative electrode 100 and the first positive electrode 300 are stacked together with a first separator configured therebetween to form a first battery cell stack (not shown) in which the tabs 101, 103, 105, 107, and 109 on the first negative electrode 100 and the tabs 301, 303, 305, 307, and 309 on the first positive electrode 300 are located on an opposite side in an alternating arrangement, substantially covering an entire length of the first battery cell stack. After adding a second separator on the top of the first positive electrode 300, the second negative electrode 200 with tabs 202 204, 206, 208, and 210 is stacked on the top of the first positive electrode 300. Furthermore, after adding a third separator on the top of the second negative electrode 200, the second positive electrode 400 with tabs 402, 404, 406, 408, and 410 is stacked to the second negative electrode 200 to form a battery cell stack. Such a process can be repeated many times until the battery cell stack has reached the desirable cell stack height (thickness).

In various embodiments, electrodes 300 and 400 have the same length and width, and tabs 301, 303, 305, 307, and 309 have the same size and shape as tabs 402, 404, 406, 408, and 410.

In various embodiments, the number of tabs on each of electrodes 100, 200, 300, and 400 is greater than 3.

In various embodiments, the height of the tabs on each of electrodes 100, 200, 300, and 400 is between 5 mm to 15 mm, and preferably between 7.5 mm and 10 mm, and the width is between 30 mm to 70 mm, and preferably between 40 and 60 mm.

In various embodiments, the first negative electrode 100 and the second negative electrode 200 have the same length and width as the first positive electrode 300 and the second positive electrode 400.

In various embodiments, the first positive electrode 300 and the second positive electrode 400 have the same number of tabs as the first negative electrode 100 and the second negative electrode 200.

In an embodiment, the length of the stacked battery cell 500 is substantially equal to the length of electrodes 100, 200, 300, and 400. The width of the stacked battery cell 500 is substantially equal to the width of electrodes 100, 200, 300, and 400. The length direction on both sides of battery cell 500 has alternating tabs, and the tabs on each side substantially occupy the entire length direction of the electrode.

In various embodiments, the length of the battery cell 500 is substantially the same as the length of the each of electrodes 100, 200, 300, and 400.

In various embodiments, the length of battery cell 500 is at least 200 mm. In various embodiments, the length of the battery cell 500 is between 200 mm and 1500 mm.

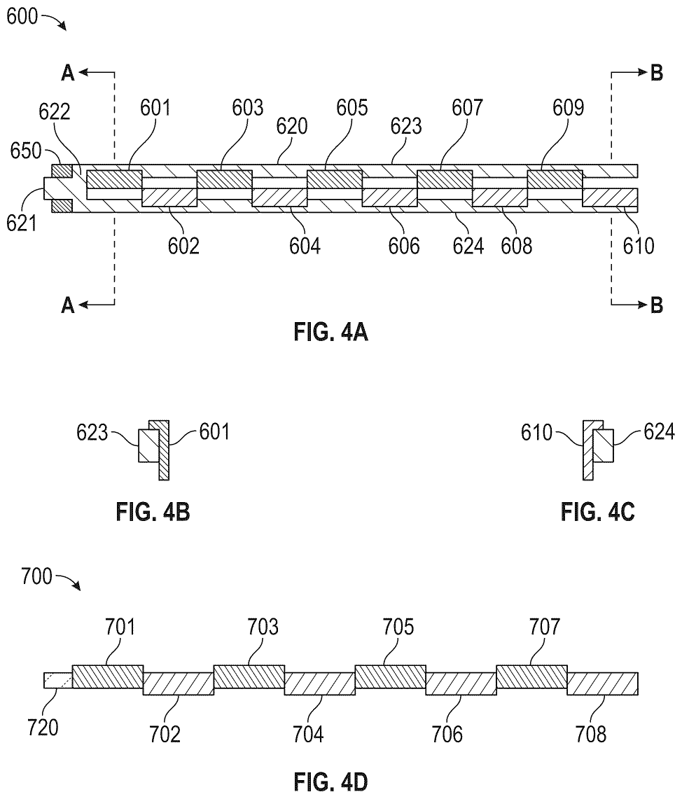

Turning now to FIG. 4A-4D, and with continued reference to FIGS. 1-3, FIG. 4A illustrates a busbar assembly 600 which includes a busbar 620 electrically connecting to tabs on the electrodes in accordance with various embodiments of the present disclosure. In an embodiment, busbar 620 includes a head 621, a shoulder 622, and two parallel legs 623 and 624 connected to the shoulder 622 with a gap between them. The length of the busbar 620 is substantially the same as the length of the battery cell 500. When the busbar 620 is assembled, tabs 601, 603, 605, 607, and 609 on an electrode pass through the gap between legs 623 and 624 and are configured to be connected to leg 623; tabs 602, 604, 606, 608, and 610 on another electrode pass through the gap between legs 623 and 624 and are configured to be connected to leg 624.

FIG. 4B illustrates the cross-sectional view of leg 623 of busbar 620 and tab 601 along the double arrow dotted line AA, in accordance with various embodiments of the present disclosure. The top end of tab 601 is bent by pressing it away from the gap to make full contact with the upper surface of leg 623. Similarly, tabs 603, 605, 607, and 609 are electrically connected to leg 623 in the same manner.

FIG. 4C illustrates the cross-sectional view of leg 624 of busbar 620 and tab 610 along the double arrow dotted line BB, in accordance with various embodiments of the present disclosure. The top end of tab 610 is bent by pressing it away from the gap to make full contact with the upper surface of leg 624. Similarly, tabs 602, 604, 606, and 608 are electrically connected to leg 624 in the same manner.

In an embodiment, head 621 is directly electrically connected to one terminal of the battery cell. The connection method can be a direct insertion method.

FIG. 4D illustrates another busbar assembly 700 which includes a busbar 720 electrically connecting to the tabs on the electrodes in accordance with various embodiments of the present disclosure. In an embodiment, busbar 700 has a strip-shaped solid structure, and the length of busbar 700 is substantially the same as the length of the battery cell 500. When busbar 700 is assembled, tabs 701, 703, 705, and 707 on an electrode are configured to be on the same side of the busbar and are bent by pressing them towards the busbar for full electrical connection; tabs 702, 704, 706, and 708 on another electrode are configured to be on the other side of the busbar and are bent by pressing them towards the busbar for full electrical connection.

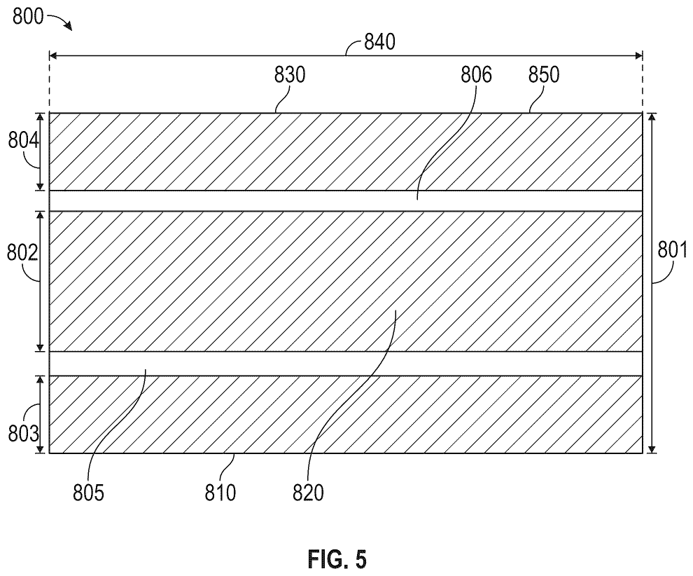

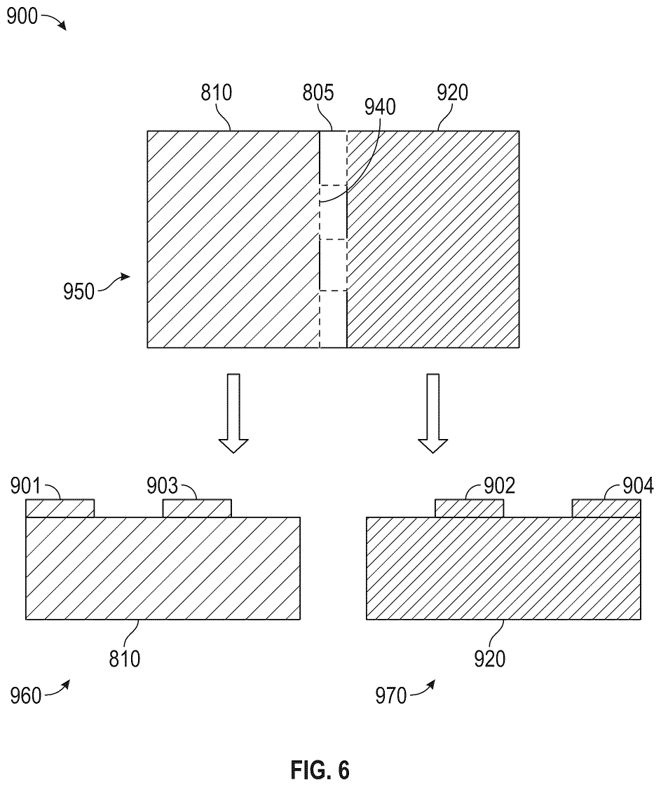

FIGS. 5-6 illustrate a method for making a battery cell, in accordance with various embodiments of the present disclosure.

In FIG. 5, a coating process 800 is illustrated. A foil 850 is fed through a coating machine (not shown in the figure), and the movement of the foil 850 from left to right defines a foil direction. Foil 850 has a defined width 801. Coating process 800 includes the following steps: applying a first coating strip 810 to foil 850; applying a second coating strip 820 to foil 850, wherein the second coating strip 820 is spaced from the first coating strip 810 by a first tab gap 805, and the width 802 of the second coating strip 820 is twice the width 803 of the first coating strip 810; applying a third coating strip 830 to foil 850, wherein the third coating strip 830 is spaced from the second coating strip 820 by a second tab gap 806, and the width 804 of the third coating strip 830 is the same as the width 803 of the first coating strip 810.

In an embodiment, coating strips 810, 820, and 830 are coated at the same time to form an electrode with coating strips 810, 820, 830, and tab gaps 805 and 806.

In FIG. 6, with continued reference to FIGS. 1-5, a notching and assembling process 900 is illustrated. Notching and assembling process 900 includes the following steps: cutting second coating strip 820 and foil 850 midway parallel to the foil direction; cutting foil 850 substantially perpendicular to the foil direction to separate a first coated blank 950 having a first half portion 920 of second coating strip 820 and a second coated blank (not shown) having a second half portion of second coating strip 820; cutting first coated blank 950 along the dotted line 940 to separate first coating strip 810 and multiple tabs 901 and 903, and separate first half portion 920 of second coating strip 820 and multiple tabs 902 and 904, wherein a first electrode 960 is formed from first coating strip 810 and tabs 901 and 903, and a second electrode 970 is formed from first half portion 920 of second coating strip 820 and tabs 902 and 904.

In various embodiments, the first coating strip 810, the second coating strip 820 and the third coating strip 830 are formed from the same active material, which is one of an anodic material and a cathodic material.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery cell, comprising:
a first negative electrode having a first defined length in a first direction and a first defined width in a second direction, wherein the first negative electrode includes tabs extending outward from one side in the second direction; and
a first positive electrode having the first defined length in the first direction and the first defined width in the second direction, wherein the first positive electrode includes tabs extending outward from one side in the second direction;
wherein the first negative electrode and the first positive electrode are stacked together with a first separator configured therebetween to form a first battery cell stack in which the tabs on the first negative electrode and the tabs on the first positive electrode are located on an opposite side in an alternating arrangement, substantially covering an entire length of the first battery cell stack.

2. The battery cell of claim 1, wherein:
the number of tabs on each of the first negative electrode and the first positive electrode is greater than 3.

3. The battery cell of claim 1, wherein:
a height of the tabs on the first negative electrode and the first positive electrode is between 5 mm and 15 mm, and a width of the tabs on the first negative electrode and the first positive electrode is between 30 mm and 70 mm.

4. The battery cell of claim 1, further comprising:
a second negative electrode having a second defined length and a second defined width, wherein the second negative electrode includes tabs extending outward from one side in the second direction;
a second positive electrode having the second defined length and the second defined width, wherein the second positive electrode includes tabs extending outward from one side in the second direction;
wherein the second negative electrode and the second positive electrode are stacked together with a second separator configured therebetween to form a second battery cell stack in which the tabs on the second negative electrode and the tabs on the second positive electrode are located on an opposite side in an alternating arrangement, substantially covering an entire length of the second battery cell stack;
wherein the first battery cell stack and the second battery cell stack are stacked together with a third separator configured therebetween to form the battery cell in which the tabs on the first negative electrode and the second negative electrode are located on a same side of the battery cell in an alternating arrangement, substantially covering an entire length of the battery cell, and the tabs on the first positive electrode and the second positive electrode are located on an opposite side of the battery cell in an alternating arrangement, substantially covering the entire length of the battery cell.

5. The battery cell of claim 4, wherein:
the first defined length is equal to the second defined length and the first defined width is equal to the second defined width.

6. The battery cell of claim 4, wherein:
the first negative electrode and the second negative electrode have a same number of tabs as the first positive electrode and the second positive electrode.

7. The battery cell of claim 4, further comprising:
a busbar, wherein the busbar includes a head, a shoulder, and two parallel legs connected to the shoulder with a gap therebetween, wherein the length of the busbar is the same as the length of the battery cell, wherein the busbar is connected to the tabs located on a same side of the battery cell, the tabs pass through the gap, and each leg is connected to all the tabs of a respective electrode.

8. The battery cell of claim 4, further comprising:
a busbar, wherein the busbar has a strip-shaped solid structure, the length of the busbar being the same as the length of the battery cell, wherein the busbar is connected to the tabs located on a same side of the battery cell such that the tabs on different electrodes are located on opposite sides of the busbar.

9. The battery cell of claim 4, wherein:
the length of the battery cell is at least 200 mm.

10. The battery cell of claim 4, wherein:
the length of the battery cell is between 200 mm and 1500 mm.

11. A battery cell module, comprising multiple battery cells, wherein each battery cell comprises:
a first negative electrode having a first defined length in a first direction and a first defined width in a second direction, wherein the first negative electrode includes tabs extending outward from one side in the second direction;
a first positive electrode having the first defined length in the first direction and the first defined width in the second direction, wherein the first positive electrode includes tabs extending outward from one side in the second direction;
wherein the first negative electrode and the first positive electrode are stacked together with a first separator configured therebetween to form a first battery cell stack in which the tabs on the first negative electrode and the tabs on the first positive electrode are located on an opposite side in an alternating arrangement, substantially covering an entire length of the first battery cell stack;
a second negative electrode having a second defined length and a second defined width, wherein the second negative electrode includes tabs extending outward from one side in the second direction;
a second positive electrode having the second defined length and the second defined width, wherein the second positive electrode includes tabs extending outward from one side in the second direction;
wherein the second negative electrode and the second positive electrode are stacked together with a second separator configured therebetween to form a second battery cell stack in which the tabs on the second negative electrode and the tabs on the second positive electrode are located on an opposite side in an alternating arrangement, substantially covering an entire length of the second battery cell stack;
wherein the first battery cell stack and the second battery cell stack are stacked together with a third separator configured therebetween to form the battery cell in which the tabs on the first negative electrode and the second negative electrode are located on a same side of the battery cell in an alternating arrangement, substantially covering an entire length of the battery cell, and the tabs on the first positive electrode and the second positive electrode are located on an opposite side of the battery cell in an alternating arrangement, substantially covering the entire length of the battery cell;
wherein each battery cell is stacked with a fourth separator and a fifth separator configured on opposite sides of the battery cell, respectively.

12. The battery cell module of claim 11, wherein:
the number of tabs on each electrode is greater than 3.

13. The battery cell module of claim 11, wherein:
the height of the tabs on each electrode is between 5 mm and 15 mm, and the width is between 30 and 70 mm.

14. The battery cell module of claim 11, wherein:
the first negative electrode and the second negative electrode have a same length and a same width as the first positive electrode and the second positive electrode.

15. The battery cell module of claim 11, wherein:
the first negative electrode and the second negative electrode have the same number of tabs as the first positive electrode and the second positive electrode.

16. The battery cell module of claim 11, wherein each battery cell further comprises:
a busbar, wherein the busbar includes a head, a shoulder, and two parallel legs connected to the shoulder with a gap between them, the length of the busbar being the same as the length of the battery cell, wherein the busbar is connected to the tabs located on a same side of the battery cell, the tabs pass through the gap, and each leg is connected to all of the tabs of a respective electrode.

17. The battery cell module of claim 11, wherein each battery cell further comprises:
a busbar for the positive or negative electrode, wherein the busbar has a strip-shaped solid structure, a length of the busbar being the same as a length of the battery cell, wherein the busbar is connected to the tabs located on a same side of the battery cell, and the tabs of adjacent electrodes are located on opposite sides of the busbar.

18. The battery cell module of claim 11, wherein:
the length of each battery cell is at least 200 mm.

19. The battery cell module of claim 11, wherein:
the length of the battery cells is between 200 mm and 1500 mm.

20. A method of forming batteries, comprising:
feeding a first foil through a coating machine, wherein movement of the first foil defines a first foil direction;
applying a first coating strip to the first foil;
applying a second coating strip to the first foil, wherein the second coating strip is spaced from the first coating strip by a first tab gap, and the width of the second coating strip is twice the width of the first coating strip;
applying a third coating strip to the first foil, wherein the third coating strip is spaced from the second coating strip by a second tab gap, and the width of the third coating strip is the same as the width of the first coating strip;
cutting the second coating strip and the first foil midway parallel to the first foil direction;
cutting the first foil substantially perpendicular to the first foil direction to separate a first coated blank having a first half portion of the second coating strip and a second coated blank having a second half portion of the second coating strip;
cutting the first coated blank to:
separate the first coating strip and a first set of plurality of tabs; and
separate the first half portion of the second coating strip and a second set of plurality of tabs, wherein a first electrode is formed from the first coating strip and the first set of plurality of tabs, and a second electrode is formed from the first half portion of the second coating strip and the second set of plurality of tabs; and
feeding a second foil through the coating machine, wherein movement of the second foil defines a second foil direction;
applying a fourth coating strip to the second foil;
applying a fifth coating strip to the second foil, wherein the fifth coating strip is spaced from the fourth coating strip by a third tab gap, and the width of the fifth coating strip is twice the width of the fourth coating strip;
applying a sixth coating strip to the second foil, wherein the sixth coating strip is spaced from the fifth coating strip by a fourth tab gap, and the width of the sixth coating strip is the same as the width of the fourth coating strip;
cutting the fifth coating strip and the second foil midway parallel to the second foil direction;
cutting the second foil substantially perpendicular to the second foil direction to separate a third coated blank having a first half portion of the fifth coating strip and a fourth coated blank having a second half portion of the fifth coating strip;
cutting the third coated blank to:
separate the fourth coating strip and a third set of plurality of tabs; and
separate the first half portion of the fifth coating strip and a fourth set of plurality of tabs, wherein a third electrode is formed from the fourth coating strip and the third set of plurality of tabs, and a fourth electrode is formed from the first half portion of the fifth coating strip and the fourth set of plurality of tabs;
wherein the first coating strip, the second coating strip and the third coating strip are formed from a same active material, which is one of an anodic material and a cathodic material, and the fourth coating trip, the fifth coating strip and the sixth coating strip are formed from a same active material, which has an opposite polarity with the active material of the first coating strip, the second coating strip and the third coating strip;
stacking the first electrode and the third electrode with a first separator configured therebetween to form a first battery cell stack in which the first set of plurality of tabs and the third set of plurality of tabs are located on an opposite side in an alternating arrangement, substantially covering an entire length of the first battery cell stack;
stacking the second electrode and the fourth electrode with a second separator configured therebetween to form a second battery cell stack in which the second set of plurality of tabs and the fourth set of plurality of tabs are located on an opposite side in an alternating arrangement, substantially covering an entire length of the second battery cell stack; and
stacking the first battery cell stack and the second battery cell stack together with a third separator configured therebetween to form a battery cell in which the tabs on the first electrode and the second electrode are located on a same side of the battery cell in an alternating arrangement, substantially covering an entire length of the battery cell, and the tabs on the third electrode and the fourth electrode are located on an opposite side of the battery cell in an alternating arrangement, substantially covering the entire length of the battery cell.
